(19) United States
(12) Patent Application Publication
(10) Pub. No.: US 2023/0289405 A1
(43) Pub. Date: Sep. 14, 2023

(54) ENTROPY CALCULATION FOR CERTAINTY-BASED CLASSIFICATION NETWORKS

(71) Applicant: Arm Limited, Cambridge (GB)

(72) Inventors: Mbou Eyole, Soham (GB); Balaji Venu, Cambridge (GB)

(73) Assignee: Arm Limited, Cambridge (GB)

(21) Appl. No.: 18/016,916

(22) PCT Filed: Jul. 19, 2021
(86) PCT No.: PCT/GB2021/051854

§ 371 Date: Jan. 19, 2023

(30) Foreign Application Priority Data
Jul. 24, 2020 (GB) 2011511.9

(51) Int. Cl. G06F 18/2415; G06F 17/11

(52) U.S. Cl. CPC G06F 18/2415; G06F 17/11

(57) ABSTRACT

An entropy calculation for certainty-based classification networks is provided. An integer operand p is received. A remainder portion of the integer operand p is determined based on a range reduction operation. A scaled integer operand is determined based on the integer operand p. An index for a data structure, such as, for example, a look-up table (LUT), is determined based on the remainder portion of the integer operand p and a parameter N associated with the data structure. A data structure value in the data structure is looked up based on the index. A scaled entropy value is generated by adding the data structure value to the scaled integer operand. An entropy value is determined based on the scaled entropy value, and the entropy value is output.

### RELATED APPLICATION

The content of United Kingdom Patent Application No. GB2011511.9, filed on 24 Jul. 2020, is incorporated herein by reference in its entirety.

### BACKGROUND

The present disclosure relates to computer systems. More particularly, the present disclosure relates to certainty-based classification networks.

Prediction is a fundamental element of many classification networks that include machine learning (ML), such as, for example, artificial neural networks (ANNs), convolutional neural networks (CNNs), recurrent neural networks (RNNs), Binary Neural Networks (BNN), Support Vector Machines (SVMs), Decision Trees, Bayesian networks, Naïve Bayes, etc. For example, safety-critical systems may implement classification networks for certain critical tasks, particularly in autonomous vehicles, robotic medical equipment, etc.

However, a classification network never achieves 100% prediction accuracy due to many reasons, such as, for example, insufficient data for a class, out of distribution (OOD) input data (i.e., data that do not belong to any of the classes), etc. Classification networks implemented in both hardware and software are also susceptible to hard and soft errors, which may worsen the prediction accuracy or lead to a fatal event. Generally, classification networks simply provide the “best” prediction based on the input data and the underlying training methodology and data.

Unfortunately, classification networks do not distinguish between correct and incorrect predictions, which can be fatal for many systems in general, and for safety-critical systems in particular.

### BRIEF DESCRIPTION OF THE DRAWINGS

FIG. 1 depicts an ANN, in accordance with embodiments of the present disclosure.

FIGS. 2A and 2B depict prediction accuracy for an ANN, in accordance with embodiments of the present disclosure.

FIG. 3 depicts a block diagram of a system, in accordance with embodiments of the present disclosure.

FIG. 4 depicts a block diagram of hardware accelerator for certainty-based classification networks, in accordance with embodiments of the present disclosure.

FIG. 5 depicts a graph of average entropy versus prediction accuracy, in accordance with an embodiment of the present disclosure.

FIG. 6A depicts the operational semantics of a processor instruction for calculating entropy, in accordance with embodiments of the present disclosure.

FIG. 6B depicts the operational semantics of a processor instruction for calculating entropy, in accordance with embodiments of the present disclosure.

FIG. 6C depicts a look-up table, in accordance with an embodiment of the present disclosure.

FIG. 7 depicts a flow diagram presenting functionality for calculating entropy for certainty-based classification networks, in accordance with an embodiment of the present disclosure.

FIG. 8A depicts a block diagram of a training system for a machine learning main classifier, in accordance with an embodiment of the present disclosure.

FIG. 8B depicts a block diagram of a threshold determination process for a machine learning main classifier, in accordance with an embodiment of the present disclosure.

### DETAILED DESCRIPTION

Embodiments of the present disclosure will now be described with reference to the drawing figures, in which like reference numerals refer to like parts throughout.

Embodiments of the present disclosure provide classification networks that identify and reduce the number of incorrect predictions based on a level of confidence, or certainty, for each prediction. In many embodiments, a prediction may have a high level of confidence (i.e., a certain prediction) or a low level of confidence (i.e., an uncertain prediction); in other embodiments, a range of confidence levels may be provided.

Generally, certainty divides the number of correct predictions for a baseline classification network into a number of correct and certain predictions (e.g., “I know” this prediction is correct) and a number of correct and uncertain predictions (e.g., “I don't know” whether this prediction is correct). Similarly, certainty divides the number of incorrect predictions for the baseline classification network into a number of incorrect and certain predictions (e.g., “I know” that this prediction is incorrect) and a number of incorrect and uncertain predictions (e.g., “I don't know” whether this prediction is incorrect). While certainty reduces the number of correct predictions of the baseline classification network to a small degree by identifying the correct and uncertain predictions, certainty significantly reduces the number of incorrect predictions of the baseline classification network by identifying the incorrect and uncertain predictions, which is advantageous for many classification systems.

Computing or estimating the uncertainty associated with the output of a classification network is an important step on the path to more transparent and explainable artificial intelligence systems. Conventional machine learning techniques have come under serious scrutiny for appearing overly confident even in cases where the classifications or responses they provide are erroneous. Concerns about characterizing the degree of uncertainty and, more generally, numerous concerns about explainability and trust, might eventually lead to fundamental changes in how computations are performed in neural networks.

Embodiments of the present disclosure advantageously provide a quick way of computing one key metric which can be used in classification networks to estimate the uncertainty associated with a given response or output, including a method and an architecture extension which ensures that arithmetic errors, which might arise if rounding and/or truncation operations are not performed properly, can be mitigated whilst retaining the efficiency benefits of integer arithmetic.

In one embodiment, a hardware accelerator for certainty-based classification networks includes a processor configured to receive an integer operand p, determine a remainder portion of the integer operand p based on a range reduction operation, determine an index fora data structure, such as, for example, a look-up table (LUT), based on the remainder portion of the integer operand p and a parameter N associated with the data structure, look up a data structure value in the data structure based on the index, generate a scaled entropy value by adding the data structure value to the scaled integer operand, determine an entropy value based on the scaled entropy value, and output the entropy value.

An ML model is a mathematical model that is trained by a learning process to generate an output, such as a supervisory signal, from an input, such as a feature vector. Neural networks, such as ANNs, CNNs, RNNs, BNNs, etc., as well as Support Vector Machines, Bayesian Networks, Naïve Bayes, K-Nearest Neighbor classifiers, etc., are types of ML models. For example, a supervised learning process trains an ML model using completely-labeled training data that include known input-output pairs. A semi-supervised or weakly-supervised learning process trains the ML model using incomplete training data, i.e., a small amount of labeled data (i.e., input-output pairs) and a large amount of unlabeled data (input only). An unsupervised learning process trains the ML model using unlabeled data (i.e., input only).

An ANN models the relationships between input data or signals and output data or signals using a network of interconnected nodes that is trained through a learning process. The nodes are arranged into various layers, including, for example, an input layer, one or more hidden layers, and an output layer. The input layer receives input data, such as, for example, image data, and the output layer generates output data, such as, for example, a probability that the image data contains a known object. Each hidden layer provides at least a partial transformation of the input data to the output data. A DNN has multiple hidden layers in order to model complex, nonlinear relationships between input data and output data.

In a fully-connected, feedforward ANN, each node is connected to all of the nodes in the preceding layer, as well as to all of the nodes in the subsequent layer. For example, each input layer node is connected to each hidden layer node, each hidden layer node is connected to each input layer node and each output layer node, and each output layer node is connected to each hidden layer node. Additional hidden layers are similarly interconnected. Each connection has a weight value, and each node has an activation function, such as, for example, a linear function, a step function, a sigmoid function, a tanh function, a rectified linear unit (ReLU) function, etc., that determines the output of the node based on the weighted sum of the inputs to the node. The input data propagates from the input layer nodes, through respective connection weights to the hidden layer nodes, and then through respective connection weights to the output layer nodes.

More particularly, at each input node, input data is provided to the activation function for that node, and the output of the activation function is then provided as an input data value to each hidden layer node. At each hidden layer node, the input data value received from each input layer node is multiplied by a respective connection weight, and the resulting products are summed or accumulated into an activation value that is provided to the activation function for that node. The output of the activation function is then provided as an input data value to each output layer node. At each output layer node, the output data value received from each hidden layer node is multiplied by a respective connection weight, and the resulting products are summed or accumulated into an activation value that is provided to the activation function for that node. The output of the activation function is then provided as output data. Additional hidden layers may be similarly configured to process data.

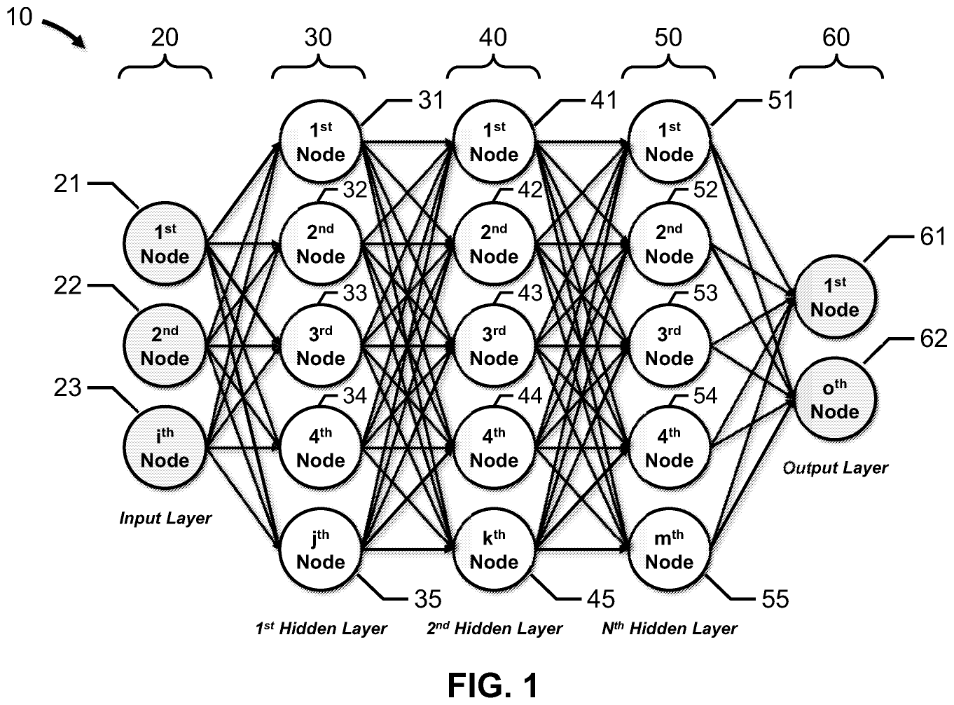

FIG. 1 depicts ANN 10, in accordance with embodiments of the present disclosure.

ANN 10 includes input layer 20, one or more hidden layers 30, 40, 50, etc., and output layer 60. Input layer 20 includes one or more input nodes 21, 22, 23, etc. Hidden layer 30 includes one or more hidden nodes 31, 32, 33, 34, 35, etc. Hidden layer 40 includes one or more hidden nodes 41, 42, 43, 44, 45, etc. Hidden layer 50 includes one or more hidden nodes 51, 52, 53, 54, 55, etc. Output layer 60 includes one or more output nodes 61, 62, etc. Generally, ANN 10 includes N hidden layers, input layer 20 includes “i” nodes, hidden layer 30 includes “j” nodes, hidden layer 40 includes “k” nodes, hidden layer 50 includes “m” nodes, and output layer 60 includes “o” nodes.

In one embodiment, N equals 3, i equals 3, j, k and m equal 5 and o equals 2 (depicted in FIG. 1). Input node 21 is coupled to hidden nodes 31 to 35, input node 22 is coupled to hidden nodes 31 to 35, and input node 23 is coupled to hidden nodes 31 to 35. Hidden node 31 is coupled to hidden nodes 41 to 45, hidden node 32 is coupled to hidden nodes 41 to 45, hidden node 33 is coupled to hidden nodes 41 to 45, hidden node 34 is coupled to hidden nodes 41 to 45, and hidden node 35 is coupled to hidden nodes 41 to 45. Hidden node 41 is coupled to hidden nodes 51 to 55, hidden node 42 is coupled to hidden nodes 51 to 55, hidden node 43 is coupled to hidden nodes 51 to 55, hidden node 44 is coupled to hidden nodes 51 to 55, and hidden node 45 is coupled to hidden nodes 51 to 55. Hidden node 51 is coupled to output nodes 61 and 62, hidden node 52 is coupled to output nodes 61 and 62, hidden node 53 is coupled to output nodes 61 and 62, hidden node 54 is coupled to output nodes 61 and 62, and hidden node 55 is coupled to output nodes 61 and 62.

Many other variations of input, hidden and output layers are clearly possible, including hidden layers that are locally-connected, rather than fully-connected, to one another.

Training an ANN includes optimizing the connection weights between nodes by minimizing the prediction error of the output data until the ANN achieves a particular level of accuracy. One method is backpropagation, or backward propagation of errors, which iteratively and recursively determines a gradient descent with respect to the connection weights, and then adjusts the connection weights to improve the performance of the network.

A multi-layer perceptron (MLP) is a fully-connected ANN that has an input layer, an output layer and one or more hidden layers. MLPs may be used for natural language processing applications, such as machine translation, speech recognition, etc. Other ANNs include recurrent neural networks (RNNs), long short-term memories (LSTMs), sequence-to-sequence models that include an encoder RNN and a decoder RNN, shallow neural networks, etc.

A CNN is a variation of an MLP that may be used for classification or recognition applications, such as image recognition, speech recognition, etc. A CNN has an input layer, an output layer and multiple hidden layers including convolutional layers, pooling layers, normalization layers, fully-connected layers, etc.

Each convolutional layer applies a sliding dot product or cross-correlation to an input volume provided by the input layer, applies an activation function to the results, and then provides the activation or output volume to the next layer. Convolutional layers typically use the ReLU function as the activation function. In some embodiments, the activation function is provided in a separate activation layer, such as, for example, a ReLU layer.

A pooling layer reduces the dimensions of the output volume received from the preceding convolutional layer, and may calculate an average or a maximum over small clusters of data, such as, for example, 2×2 matrices. In some embodiments, a convolutional layer and a pooling layer may form a single layer of a CNN.

The fully-connected layers follow the convolutional and pooling layers, and include a flatten layer and a classification layer, followed by a normalization layer that includes a normalization function, such as the SoftMax function. The output layer follows the last fully-connected layer; in some embodiments, the output layer may include the normalization function.

Generally, classification networks, such as ANNs, CNNs, RNNs, etc., that perform pattern recognition (e.g., image, speech, activity, etc.) may be implemented in hardware, a combination of hardware and software, or software. Many classification networks predict a finite set of classes. A classification network for an autonomous vehicle may have a set of image classes that include, for example, “pedestrian,” “bicycle,” “vehicle,” “animal,” “traffic sign,” “traffic light,” “junction,” “exit,” “litter,” etc. Some of these classes are extremely important to predict in real time; otherwise, an incorrect prediction may lead to an injury or death. For example, “pedestrian,” “bicycle,” “vehicle,” etc. may be defined as important classes, while “animal,” “traffic sign,” “traffic light,” “junction,” “exit,” “litter,” etc. may not be defined as important.

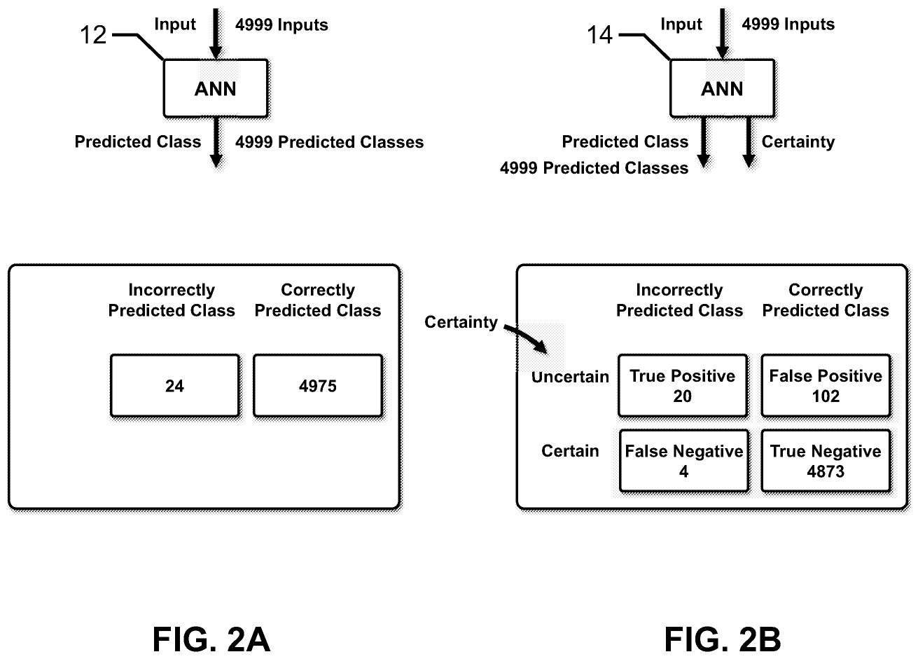

FIGS. 2A and 2B depict prediction accuracy for an ANN, in accordance with embodiments of the present disclosure.

FIG. 2A depicts baseline ANN 12, according to one embodiment of the present disclosure. In one example, baseline ANN 12 received 4,999 inputs associated with 4,999 known classes, and output 4,999 predicted classes. In this example, baseline ANN 12 correctly predicted 4,975 classes and incorrectly predicted 24 classes. Since baseline ANN 12 can not distinguish between correctly predicted classes and incorrectly predicted classes, all of the predicted classes are subsequently processed the same way, which yields an accuracy of 99.7% (i.e., precision=4,975/4,999). As discussed above, it is important to have the fewest number of incorrectly predicted classes because an incorrectly predicted class can be fatal for many systems in general, and for safety-critical systems in particular.

FIG. 2B depicts certainty-based ANN 14, according to an embodiment of the present disclosure. While certainty-based ANN 14 generates a predicted class for each input and a certainty for each predicted class, baseline ANN 12 and certainty-based ANN 14 were trained using the same training methodology and data. Using the same data provided to baseline ANN 12, certainty-based ANN 14 received 4,999 inputs associated with 4,999 known classes, and output 4,999 predicted classes and 4,999 certainty values. A prediction was identified as either “certain” (i.e., “I know” this prediction is correct), or uncertain (i.e., “I don't know” whether this prediction is correct). In this embodiment, two levels of confidence are provided, i.e., a high level (positive) and a low level (negative); in other embodiments, a range of confidence levels may be provided.

Certainty-based ANN 14 correctly predicted 4,873 classes with certainty (i.e., a “true negative” condition), correctly predicted 102 classes with uncertainty (i.e., a “false positive” condition), incorrectly predicted 4 classes with certainty (i.e., a “false negative” condition), and incorrectly predicted 20 classes with uncertainty (i.e., a “true positive” condition). The false negative condition is a dangerous situation from a safety perspective. Since certainty-based ANN 14 distinguishes between certain and uncertain predicted classes, these predicted classes may be subsequently processed in different ways. In one embodiment, the uncertain predicted classes may simply be discarded, which yields an accuracy of 99.9% (e.g., precision=4873/(4873+4)) and a reduction in the number of incorrectly predicted classes of 83.3% (e.g., recall=20/(20+4)). In other embodiments, uncertain predicted classes may be re-evaluated and promoted to certain predicted classes based on predictions from additional classification networks, uncertain predicted classes may be replaced by predicted classes from additional classification networks, etc.

Importantly, because all of the certain predicted classes are subsequently processed the same way, the number of incorrectly predicted classes that are subsequently processed has been significantly reduced from 24 classes to 4 classes, which is advantageous for many systems in general, and for safety-critical systems in particular. Determination of certainty is discussed in detail below. In some embodiments, an uncertain prediction may invoke an escalation procedure, such as, for example, ANN 14 may send a notification to a display to alert a human operator when a prediction is uncertain.

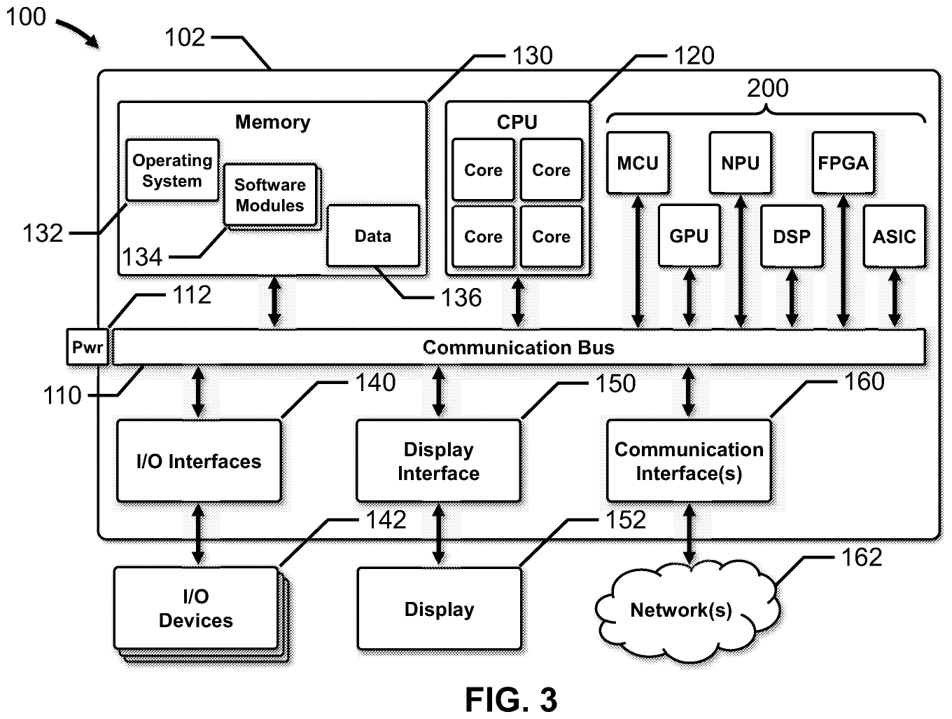

FIG. 3 depicts a block diagram of system 100, in accordance with embodiments of the present disclosure.

System 100 includes computer 102, I/O devices 142 and display 152. Computer 102 includes communication bus 110 coupled to one or more processors 120, memory 130, I/O interfaces 140, display interface 150, one or more communication interfaces 160, and one or more HAs 200. Generally, I/O interfaces 140 are coupled to I/O devices 142 using a wired or wireless connection, display interface 150 is coupled to display 152, and communication interface 160 is connected to network 162 using a wired or wireless connection. In some embodiments, certain components of computer 102 are implemented as a system-on-chip (SoC); in other embodiments, computer 102 may be hosted on a traditional printed circuit board, motherboard, etc.

In some embodiments, system 100 is an embedded system in which one or more of the components depicted in FIG. 3 are not present, such as, for example, I/O interfaces 140, I/O devices 142, display interface 150, display 152, etc. Additionally, certain components, when present, may be optimized based on various design constraints, such as, for example, power, area, etc., such as, for example, HA 200.

Communication bus 110 is a communication system that transfers data between processor 120, memory 130, I/O interfaces 140, display interface 150, communication interface 160, HAs 200, as well as other components not depicted in FIG. 3. Power connector 112 is coupled to communication bus 110 and a power supply (not shown). In some embodiments, communication bus 110 is a network-on-chip (NoC).

Processor 120 includes one or more general-purpose or application-specific microprocessors that executes instructions to perform control, computation, input/output, etc. functions for system 100. Processor 120 may include a single integrated circuit, such as a micro-processing device, or multiple integrated circuit devices and/or circuit boards working in cooperation to accomplish the functions of processor 120. Additionally, processor 120 may include multiple processing cores, as depicted in FIG. 3. Generally, system 100 may include one or more processors 120, each containing one or more processing cores as well as various other modules.

In some embodiments, system 100 may include 2 processors 120, each containing multiple processing cores. For example, one processor 120 may be a high performance processor containing 4 “big” processing cores, e.g., Arm Cortex-A73, Cortex-A75, Cortex-A76, etc., while the other processor 120 may be a high efficiency processor containing 4 “little” processing cores, e.g., Arm Cortex-53, Arm Cortex-55, etc. In this example, the “big” processing cores include a memory management unit (MMU). In other embodiments, system 100 may be an embedded system that includes a single processor 120 with one or more processing cores, such as, for example, an Arm Cortex-M core. In these embodiments, processor 120 typically includes a memory protection unit (MPU).

In many embodiments, processor 120 may also be configured to execute classification-based machine learning (ML) models, such as, for example, ANNs, DNNs, CNNs, RNNs, SVM, Naïve Bayes, etc. In these embodiments, processor 120 may provide the same functionality as a hardware accelerator, such as HA 200. For example, system 100 may be an embedded system that does not include HA 200.

In addition, processor 120 may execute computer programs or modules, such as operating system 132, software modules 134, etc., stored within memory 130. For example, software modules 134 may include an autonomous vehicle application, a robotic application, such as, for example, a robot performing a surgical process, working with humans in a collaborative environment, etc., which may include a classification network, such as, for example, an ANN, a CNN, an RNN, a BNN, an SVM, Decision Trees, Bayesian networks, Naïve Bayes, etc.

Generally, storage element or memory 130 stores instructions for execution by processor 120 and data. Memory 130 may include a variety of non-transitory computer-readable medium that may be accessed by processor 120. In various embodiments, memory 130 may include volatile and nonvolatile medium, non-removable medium and/or removable medium. For example, memory 130 may include any combination of random access memory (RAM), DRAM, SRAM, ROM, flash memory, cache memory, and/or any other type of non-transitory computer-readable medium.

Memory 130 contains various components for retrieving, presenting, modifying, and storing data. For example, memory 130 stores software modules that provide functionality when executed by processor 120. The software modules include operating system 132 that provides operating system functionality for system 100. Software modules 134 provide various functionality, such as image classification using CNNs, etc. Data 136 may include data associated with operating system 132, software modules 134, etc.

I/O interfaces 140 are configured to transmit and/or receive data from I/O devices 142. I/O interfaces 140 enable connectivity between processor 120 and I/O devices 142 by encoding data to be sent from processor 120 to I/O devices 142, and decoding data received from I/O devices 142 for processor 120. Generally, data may be sent over wired and/or wireless connections. For example, I/O interfaces 140 may include one or more wired communications interfaces, such as USB, Ethernet, etc., and/or one or more wireless communications interfaces, coupled to one or more antennas, such as WiFi, Bluetooth, cellular, etc.

Generally, I/O devices 142 provide input to system 100 and/or output from system 100. As discussed above, I/O devices 142 are operably connected to system 100 using a wired and/or wireless connection. I/O devices 142 may include a local processor coupled to a communication interface that is configured to communicate with system 100 using the wired and/or wireless connection. For example, I/O devices 142 may include a keyboard, mouse, touch pad, joystick, etc., sensors, actuators, etc.

Display interface 150 is configured to transmit image data from system 100 to monitor or display 152.

Communication interface 160 is configured to transmit data to and from network 162 using one or more wired and/or wireless connections. Network 162 may include one or more local area networks, wide area networks, the Internet, etc., which may execute various network protocols, such as, for example, wired and/or wireless Ethernet, Bluetooth, etc. Network 162 may also include various combinations of wired and/or wireless physical layers, such as, for example, copper wire or coaxial cable networks, fiber optic networks, Bluetooth wireless networks, WiFi wireless networks, CDMA, FDMA and TDMA cellular wireless networks, etc.

HAs 200 are configured to execute, inter alia, classification networks, such as, for example, ANNs, CNNs, etc., in support of various applications embodied by software modules 134. Generally, HAs 200 include one or more processors, coprocessors, processing engines (PEs), compute engines (CEs), etc., such as, for example, CPUs, GPUs, NPUs (e.g., the ARM ML Processor), DSPs, field programmable gate arrays (FPGAs), application specific integrated circuits (ASICs), controllers, microcontrollers, matrix multiplier circuits, MAC arrays, etc. HAs 200 also include a communication bus interface as well as non-volatile and/or volatile memories, such as, for example, ROM, flash memory, SRAM, DRAM, etc.

In many embodiments, HA 200 receives the ANN model and weights from memory 130 over communication bus 110 for storage in local volatile memory (e.g., SRAM, DRAM, etc.). In other embodiments, HA 200 receives a portion of the ANN model and weights from memory 130 over communication bus 110. In these embodiments, HA 200 determines the instructions needed to execute the ANN model or ANN model portion. In other embodiments, the ANN model (or ANN model portion) simply includes the instructions needed to execute the ANN model (or ANN model portion). In these embodiments, processor 120 determines the instructions needed to execute the ANN model, or, processor 120 divides the ANN model into ANN model portions, and then determines the instructions needed to execute each ANN model portion. The instructions are then provided to HA 200 as the ANN model or ANN model portion.

In further embodiments, HA 200 may store ANN models, instructions and weights in non-volatile memory. In some embodiments, the ANN model may be directly implemented in hardware using DSPs, FPGAs, ASICs, controllers, microcontrollers, adder circuits, multiply circuits, MAC circuits, etc. Generally, HA 200 receives input data from memory 130 over communication bus 110, and transmit output data to memory 130 over communication bus 110. In some embodiments, the input data may be associated with a layer (or portion of a layer) of the ANN model, and the output data from that layer (or portion of that layer) may be transmitted to memory 130 over communication bus 110.

For example, the ARM ML Processor supports a variety of ANNs, CNNs RNNs, etc., for classification, object detection, image enhancements, speech recognition and natural language understanding. The ARM ML Processor includes a control unit, a direct memory access (DMA) engine, local memory and 16 CEs. Each CE includes, inter alia, a MAC engine that performs convolution operations, a programmable layer engine (PLE), local SRAM, a weight decoder, a control unit, a direct memory access (DMA) engine, etc. Each MAC engine performs up to eight 16-wide dot products with accumulation. Generally, the PLE performs non-convolution operations, such as, for example, pooling operations, ReLU activations, etc. Each CE receives input feature maps (IFMs) and weights sets over the NoC and stores them in local SRAM. The MAC engine and PLE process the IFMs to generate the output feature maps (OFMs), which are also stored in local SRAM prior to transmission over the NoC.

In other embodiments, HA 200 may also include specific, dedicated hardware components that are configured to execute a pre-trained, pre-programmed, hardware-based classification network. These hardware components may include, for example, DSPs, FPGAs, ASICs, controllers, microcontrollers, multiply circuits, add circuits, MAC circuits, etc. The pre-trained, pre-programmed, hardware-based classification network receives input data, such as IFMs, and outputs one or more predictions. For hardware-based classification networks that include small ANNs, the weights, activation functions, etc., are pre-programmed into the hardware components. Generally, hardware-based classification networks provide certain benefits over more traditional hardware accelerators that employ CPUs, GPUs, PE arrays, CE arrays, etc., such as, for example, processing speed, efficiency, reduced power consumption, reduced area, etc. However, these benefits are achieved at a price—the size of the classification network is typically small, and there is little (to no) ability to upgrade or expand the hardware components, circuits, etc. in order to update the classification network.

In many embodiments, HA 200 includes one or more processors, coprocessors, PEs, CEs, etc., that are configured to execute two or more large, main classification networks as well as one or more small, expert classification networks. In some embodiments, the expert classification networks may be pre-trained, pre-programmed, hardware-based classification networks. In these embodiments, in addition to the processors, coprocessors, PEs, CEs, etc. that are configured to execute the main classification network, HA 200 includes additional hardware components, such as DSPs, FPGAs, ASICs, controllers, microcontrollers, multiply circuits, add circuits, MAC circuits, etc., that are configured to execute each expert classification network as a separate, hardware-based classification network.

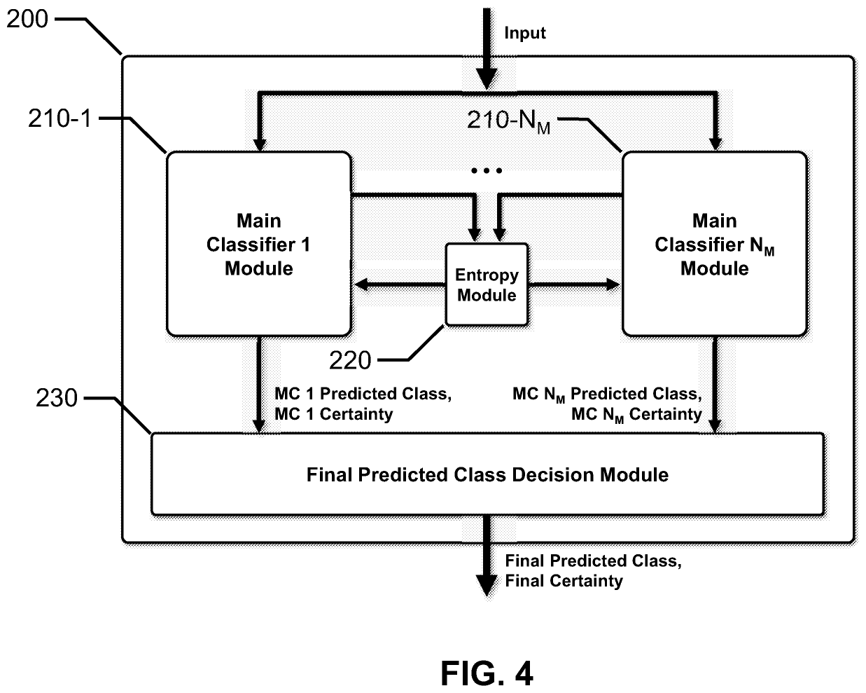

FIG. 4 depicts a block diagram of hardware accelerator 200 for certainty-based classification networks, in accordance with embodiments of the present disclosure.

Generally, as discussed above, HA 200 may include, inter alia, one or more processors, coprocessors, PEs, CEs, CPUs, GPUs, NPUs, DSPs, FPGAs, ASICs, controllers, microcontrollers, matrix multiplier circuits, MAC arrays, etc., as well as a communication bus interface as well as non-volatile and/or volatile memories, such as, for example, ROM, flash memory, SRAM, DRAM, etc., a communication bus interface, etc.

HA 200 is configured to execute two or more main classifier (MC) modules, i.e., MC 1 module 210-1 to MC N_{M} module 210 N_{M}, entropy module 220 and final predicted class decision module 230. In many embodiments, N_{M} equals 2. For clarity, the features of HA 200 are discussed below for embodiments including two MC modules, i.e., MC 1 module 210-1 and MC 2 module 210-2; however, these features are extendible to embodiments including three or more MC modules.

In many embodiments, MC 1 module 210-1, MC 2 module 210-2, entropy module 220 and final predicted class decision module 230 are software modules that may be stored in local non-volatile local memory, or, alternatively, stored in memory 130 and sent to HA 200 via communication bus 110, as discussed above. In some embodiments, one or more of MC 1 module 210-1, MC 2 module 210-2, entropy module 220 and final predicted class decision module 230 may be hardware-based. In other embodiments, one or more of MC 1 module 210-1, MC 2 module 210-2, entropy module 220 and final predicted class decision module 230 may be a combination of software and hardware. In many embodiments, entropy module 220 may be implemented as one or more processor instructions, as discussed below.

For example, MC 1 module 210-1 may include, inter alia, a software-based classification network and a software component that determines certainty based on an entropy calculation performed by entropy module 220. Similarly, MC 2 module 210-2 may include, inter alia, a different software-based classification network, a software component that determines certainty based on an entropy calculation performed by entropy module 220. Final predicted class decision module 230 may be a software or hardware component.

MC 1 module 210-1 includes a certainty-based classification network or main classifier 1, such as ANN 14, that receives input data sent by processor 120 via communication bus 110, and generates a predicted class and a certainty based on the input data. Similarly, MC 2 module 210-2 includes a certainty-based classification network or main classifier 2, such as ANN 14, that receives the same input data as MC 1 module 210-1, and generates a predicted class and a certainty based on the input data. The MC 1 predicted class, the MC 1 certainty, the MC 2 predicted class and the MC 2 certainty are provided to final predicted class decision module 230, which determines the final predicted class and final certainty, which are sent to processor 120 via communication bus 110. The MC 1 certainty indicates whether the MC 1 predicted class is certain or uncertain, the MC 2 certainty indicates whether the MC 2 predicted class is certain or uncertain, and the final certainty indicates whether the final predicted class is certain or uncertain.

In many embodiments, main classifier 1 and main classifier 2 are diverse classification networks, which means that main classifier 1 and main classifier 2 generate a minimal overlap of errors, e.g., incorrectly predicted classes. For example, main classifier 2 may have a slightly different ANN architecture than main classifier 1, main classifier 2 may have been trained using a different training methodology than main classifier 1, main classifier 2 may have been trained using different training data than main classifier 1, etc.; combinations of these and other factors may also be employed to create diverse classification networks.

Generally, uncertainty may be estimated by intercepting and performing a readout of values from the ANN, and then analyzing certain properties of the distribution of those values. In many embodiments, the output of the normalization or output layer, which includes a normalization function such as the SoftMax function, may be used for this purpose; in other embodiments, other intermediate signals in the ANN may be intercepted and analyzed. The normalization or Softmax layer represents a good interception point for uncertainty estimation because it routinely performs normalization in ANNs by effectively mapping non-normalized output values to a probability distribution over predicted output classes.

Generally, MC 1 module 210-1 determines the MC 1 certainty based on the probability that is generated for each class. In one embodiment, the main classifier 1 is an ANN that includes an input layer, one or more hidden layers and an output layer that has a number of output nodes, and each output node generates a probability for an associated class. In many embodiments, MC 1 module 210-1 determines the MC 1 certainty based on a calculation of the entropy of the probabilities of the associated classes performed by entropy module 220; other methods for determining certainty are also contemplated. For example, the entropy may be calculated based on a sum of each output node probability times a value approximately equal to a binary logarithm of the output node probability, as given by Eq. 1.

$$entropy = - {\sum }_{k = 0}^{n - 1} {p}_{k} {log}_{2} {p}_{k} \qquad Eq . 1$$

where pₖ is an output node probability determined by the Softmax function, and n is the number of nodes. Since pₖ has a range of values between 0 and 1, the binary logarithm of pₖ will be a negative number, so the sign of the sum is reversed to force the entropy to be a positive number. In many embodiments, a look up table may be used to approximate the output of the binary logarithm function, log₂(x).

Generally, an output is classified as confident if the Softmax layer outputs are such that only one of the probability values is very high and the other values are close to zero. The computed entropy of such a confident output will also be close to zero. Conversely, an output is classified as not confident if the Softmax layer outputs are such that there are multiple probability values which are high. The computed entropy of such an output will be greater than some threshold.

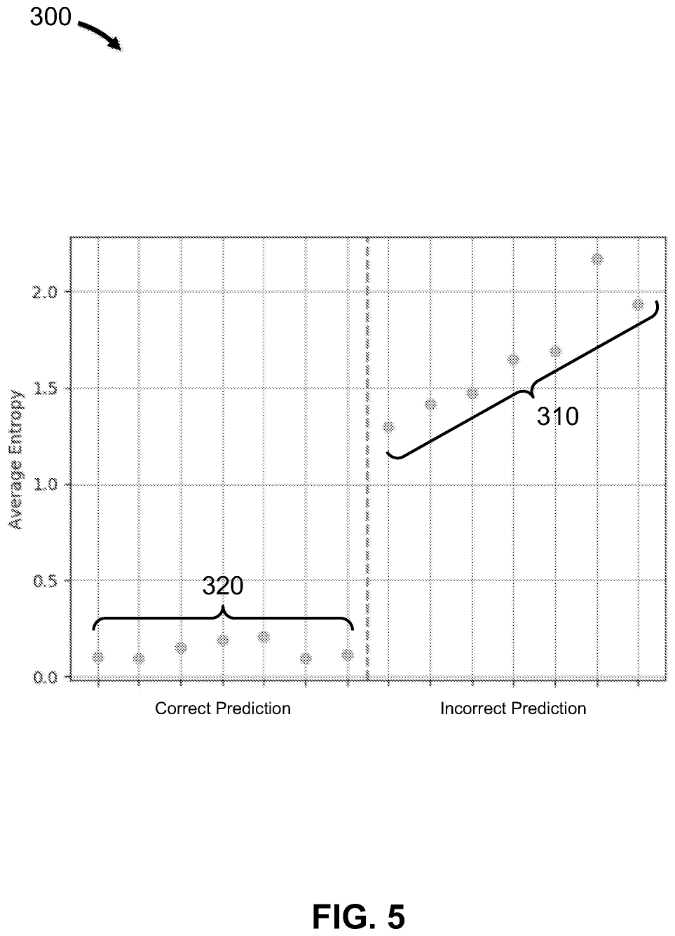

FIG. 5 depicts a graph 300 of average entropy versus prediction accuracy, in accordance with an embodiment of the present disclosure. Samples 310 were incorrect classifications by the network and exhibit high entropy (e.g., entropy grater than 1), while samples 320 were correctly classified and exhibit low entropy (e.g., entropy less than ˜0.4).

MC 1 module 210-1 determines that the MC 1 certainty is certain when the entropy is less than a predetermined threshold, and uncertain when the entropy is equal to or greater than the predetermined threshold. In many embodiments, the MC 1 certainty is a binary value, the output node probabilities are between 0 and 1, and the predetermined threshold is a fixed numeric value. The predetermined threshold is determined during training, discussed below. For example, the predetermined threshold for the entropy calculations depicted in FIG. 5 is 1.

Similarly, MC 2 module 210-2 determines the MC 2 certainty based on the probability that is generated for each class. In one embodiment, the main classifier 2 is a diverse ANN that includes an input layer, one or more hidden layers and an output layer that has a number of output nodes, and each output node generates a probability for an associated class. In many embodiments, MC 2 module 210-2 determines the MC 2 certainty based on a calculation of the entropy of the probabilities of the associated classes performed by entropy module 220; other methods for determining certainty are also contemplated. MC 2 module 210-2 determines that the MC 2 certainty is certain when the entropy is less than a predetermined threshold, and uncertain when the entropy is equal to or greater than the predetermined threshold. In many embodiments, the MC 2 certainty is a binary value, the output node probabilities are between 0 and 1, and the predetermined threshold is determined during training, as discussed below.

Final predicted class decision module 230 determines the final predicted class and the final certainty based on the MC 1 certainty, the MC 2 certainty, the MC 1 predicted class and the MC 2 predicted class. Advantageously, the manner in which certainty estimates from the MCs are combined to generate the final certainty is configurable both during training and inference. In many embodiments, a look-up table may be used to determine the final predicted class and the final certainty, such as, for example, Table 1; other logic mechanisms also contemplated.

TABLE 1

| MC 1 | MC 2 | Final | Final | Predicted Class |
|---|---|---|---|---|
| Certainty | Certainty | Certainty | Predicted Class | MC 1 = MC 2? |
| Uncertain | Uncertain | Uncertain | None | — |
| Uncertain | Certain | Uncertain | None | — |
| Certain | Uncertain | Uncertain | None | — |
| Certain | Certain | Uncertain | None | No |
| | | Certain | MC 1 (MC 2) | Yes |

More particularly, when MC 1 certainty is uncertain and MC 2 certainty is uncertain, the final certainty is uncertain and the final predicted class is indeterminate (i.e., none), which may be represented as a null value (e.g., 0), a pre-determined value indicating an indeterminate predicted class, etc. When MC 1 certainty is uncertain and MC 2 certainty is certain, the final certainty is uncertain and the final predicted class is indeterminate. When MC 1 certainty is certain and MC 2 certainty is uncertain, the final certainty is uncertain and the final predicted class is indeterminate.

When MC 1 certainty is certain and MC 2 certainty is certain, the final certainty and the final predicted class depend upon whether the MC 1 predicted class matches the MC 2 predicted class. When the MC 1 predicted class does not match the MC 2 predicted class, then the final certainty is uncertain and the final predicted class is indeterminate. When the MC 1 predicted class matches the MC 2 predicted class, then the final certainty is certain and the final predicted class is the MC 1 predicted class (which is also the MC 2 predicted class).

HA 200 eliminates many certain, incorrectly predicted classes (i.e., the false negative condition discussed with respect to FIG. 2B), which is advantageous from an accuracy perspective, at the expense of potentially increasing uncertain, correctly predicted classes (i.e., the false positive condition discussed with respect to FIG. 2B). While accuracy is important, compromising functionality by reducing the number of correctly predicted classes may impact the overall efficacy of the system, degrade user experience, etc. As apparent from Table 1, for a naïve diverse system with two classification networks, all but one combination of MC 1 certainty and MC 2 certainty results in an indeterminate final predicted class, and that combination still requires that the MC 1 predicted class match the MC 2 predicted class before an actual final predicted class is output by final predicted class decision module 230.

Many modern ANNs operate with quantized values for their weights and activations, and good overall accuracies may be obtained when implementations with reduced precision (or only a small number of bits) are utilized. Such reduced precision implementations present attractive optimization points due to their inherent speed and efficiency. So, for example, many implementations would tend to favor low-precision integer arithmetic over floating point arithmetic. However, many CPUs, GPUs, NPUs, etc. do not support fast entropy calculation for quantized ANNs while remaining in an efficient precision regime.

The entropy calculation must be fast enough to be appended to the selected layer of the ANN without causing any undue increase in memory traffic or creating an adverse impact on the network's throughput. Simply upconverting the precision of the values may require more energy and/or slow down the ANN, while simply rounding or truncating values without paying adequate attention to the discrepancy in the numerical range between p and log₂(p) may render the entropy calculation too inaccurate.

For example, while the Count Leading Zeroes (CLZ) instruction found in many processor architectures can quickly provide the truncated base 2 logarithm of an integer, multiplying this result by the same integral value and then attempting to sum a number of such products would be numerically catastrophic without appropriate care. The asymmetry in the numerical range is exacerbated by the fact that a summation needs to be performed across several classes so any rounding errors might accumulate in a deleterious manner. In the case of a vector processor which upconverts the precision of the values used as vector operands, the throughput of vector processing would be reduced because, in the absence of special architectural support, many operations would have to be performed with larger vector element sizes thereby reducing computational density.

Embodiments of the present disclosure advantageously provide an entropy module 220 that is fast, efficient and does not cause any undue increase in memory traffic or adverse impact on the ANN's throughput. In many embodiments, entropy module 220 is implemented as processor instructions. In one embodiment, three new instructions are listed in Table 2. The first instruction is a vector variant with multi-precision pairwise addition, the second instruction is a vector variant (odd/even forms) without pairwise addition, and the third instruction is a scalar variant with accumulation. The arguments include <Zn> (the vector source register), <Zd> (the vector destination register), <Pg> (the predicate), <Ta> (the element size for the vector destination register), <Tb> (the element size for the vector source register), <Xdn> (the scalar destination register), and Xm (the scalar source register). These instructions are multi-precision in the sense that <Tb> is smaller than <Ta> (e.g., 8-bit elements vs. 16-bit elements, etc.).

TABLE 2

| Instruction | Syntax |
|---|---|
| 1 | NTRPY <Zd>.<Ta>, <Pg>/Z, <Zn>.<Tb> |
| 2 | NTRPY{B/T} <Zd>.<Ta>, <Pg>/Z, <Zn>.<Tb> |
| 3 | NTRPY <Xdn>, <Xm> |

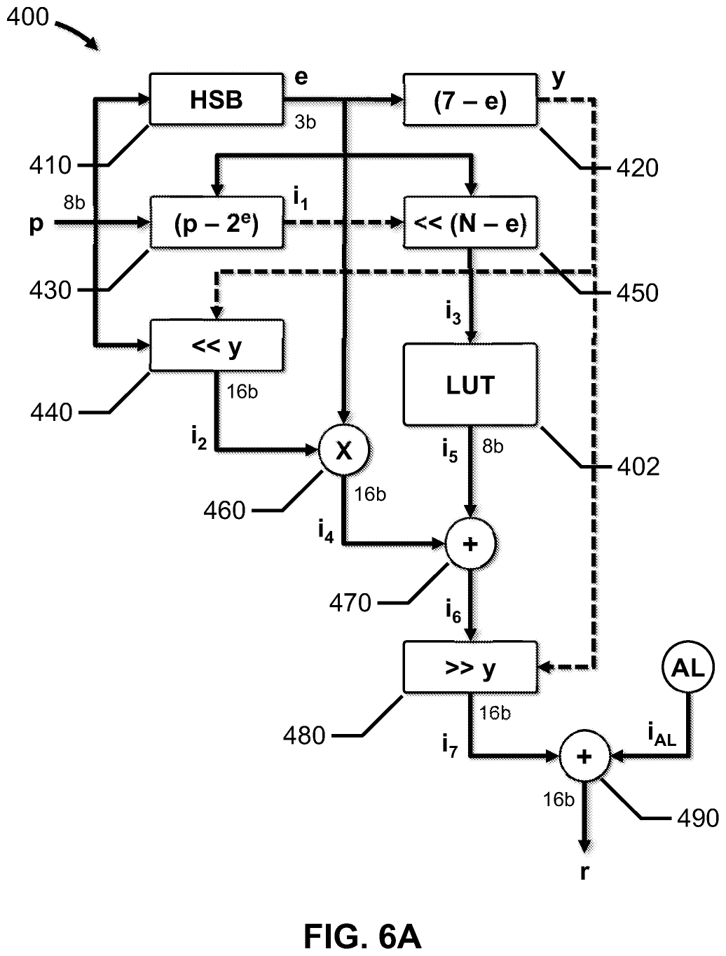

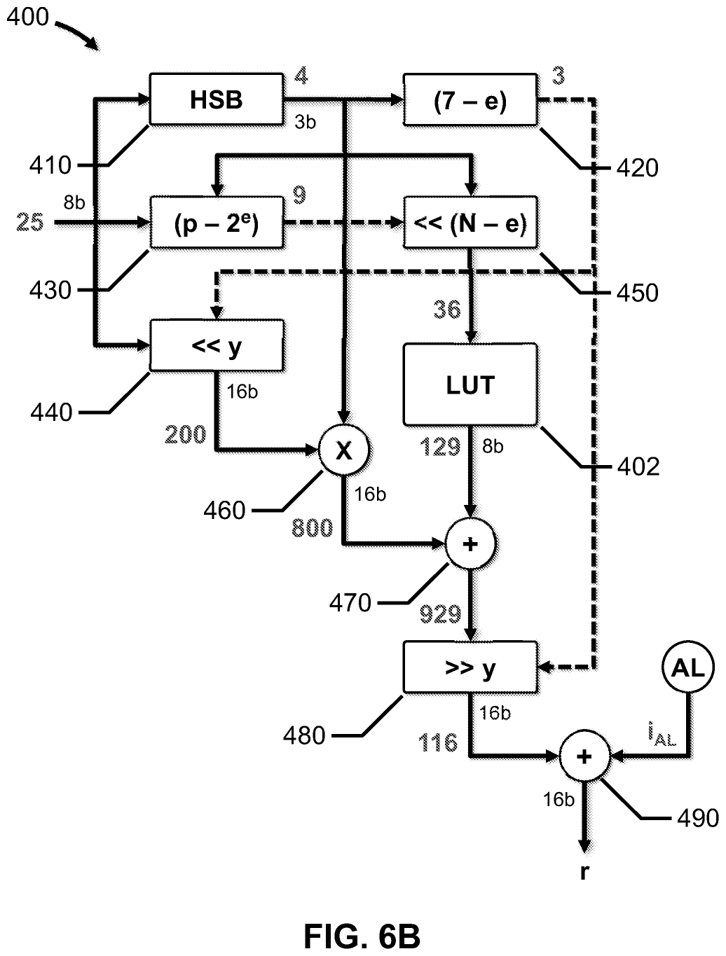

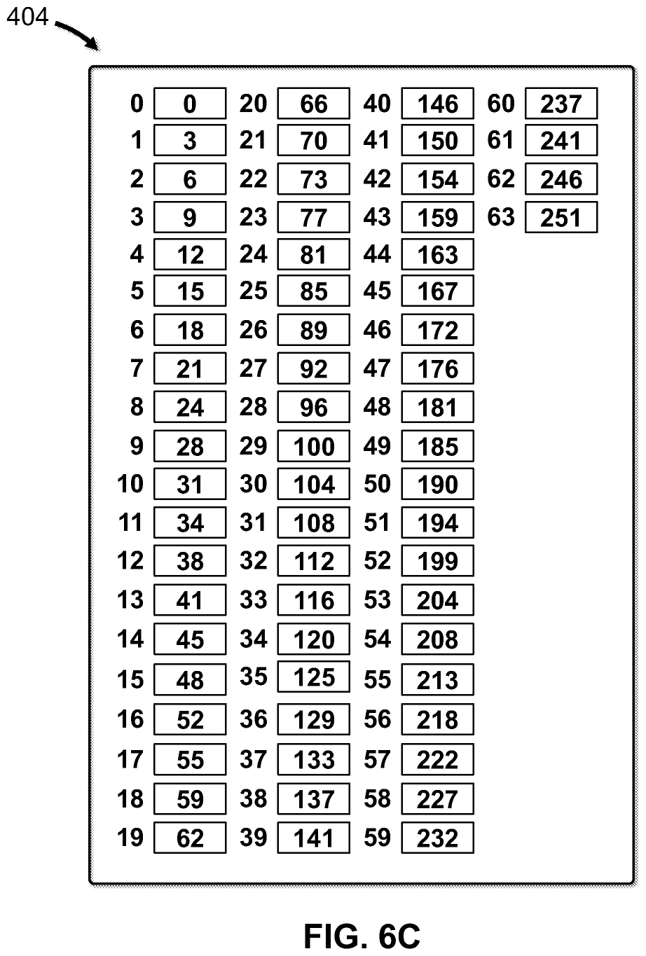

FIG. 6A depicts the operational semantics 400 of a processor instruction for calculating entropy, in accordance with embodiments of the present disclosure.

While operational semantics 400 depicted in FIG. 6A are presented with respect to instruction 1, the operational semantics of instructions 2 and 3 can be easily derived from instruction 1. For example, in the case of instruction 2, the even-numbered vector lanes and odd-numbered vector lanes are processed alternately and only half the number of elements within the input source vector operand is processed at a time. In this case, the pairwise addition (i.e., addition operation 490) can be omitted (e.g., to improve the timing of instruction) and the destination vector will contain 16-bit elements, each corresponding to a 16-bit granule in the source vector which has been split into 2 halves: a top 8-bit portion and a bottom 8-bit portion.

Instructions 1 and 2 are predicated operations, which adds flexibility, and improves performance in certain embodiments, because these instructions enable the programmer to use an input predicate to discount the entropy calculation for some classes. For instruction 3, the 16-bit result of the operation can be accumulated with the current value in the destination register before writing back the final result to the destination register.

Operational semantics 400 calculates entropy using a simplified version of Equation 1, and includes look-up table (LUT) operation 402 to approximate the product of an integer and the binary logarithm operation of that integer, e.g., m·log₂(m). Equation 2 derives the simplification, with the understanding that log₂(a·b)=log₂(a)+log₂(b), log₂(2^{e})=e, and c·2^{e}=c<<e. Equation 3 presents the simplified version of Equation 1.

p log₂ p→m2^{e} log₂[m2^{e}]→m2^{e}(e+log₂[m]) Eq. 2

p log₂p=(me+m log₂[m])<<e Eq. 3

Operational semantics 400 includes highest set bit (HSB) operation 410, subtraction operation 420, subtraction operation 430, left shift operation 440, left shift operation 450, data structure or LUT operation 402, multiplication operation 460, addition operation 470 right shift operation 480 and pairwise addition operation 490. Operational semantics 400 receives operand p as an input, and provides result r as an output. In this embodiment, operand p is an 8-bit value, and result r is a 16-bit value; other sizes of operands and results are also contemplated. The entropy for an operand p that has a value of 1 is set to 0, because log₂(1)=0.

HSB operation 410 receives operand p, determines highest set bite, i.e., the highest bit position, from left to right, of the first bit set to 1, and outputs highest set bit e to subtraction operation 420, subtraction operation 430, left shift operation 450 and multiplication operation 460. In this embodiment, highest set bit e is a 3 bit value. For example, if operand p has a decimal value of 25 (i.e., a binary value of 0001 1001), then highest set bit e has a value of 4 (i.e., the fourth bit position from the left).

Subtraction operation 420 receives highest set bit e, determines the quantity “7−e,” and outputs the result, y, to left shift operation 440 and right shift operation 480. For example, if highest set bit e has a value of 4, then y has a value of 3 (i.e., 7−4=3).

Subtraction operation 430 receives operand p and highest set bit e, determines the quantity “p−2^{e},” and outputs the intermediate value i₁ to left shift operation 450. For example, if operand p has a value of 25 and highest set bit e has a value of 4, then i₁ has a value of 9 (i.e., 25−2⁴=25−16=9).

Left shift operation 440 receives operand p and y, left shifts operand p by y bits, and outputs the intermediate value i₂ to multiplication operation 460. In this embodiment, intermediate value i₂ is a 16 bit value. For example, if operand p has a value of 25 and y has a value of 3, then i₂ has a value of 200 (i.e., 25<<3=25*2³=25*8=200).

Left shift operation 450 receives intermediate value i₁ and highest set bit e, determines the quantity “N−e,” left shifts the intermediate value i₁ by “N−e” bits, and outputs the intermediate value i₃ to LUT operation 402. The value N is equal to the binary logarithm of the number of entries in the look up table of LUT operation 402. For example, if the look up table includes 64 entries, then N has the value of 6 (i.e., log₂(64)=6), and, if highest set bit e has a value of 4 and intermediate value i₁ has a value of 9, then the quantity “N−e” has the value of 2 (i.e., 6−4=2), and intermediate value i₃ has the value of 36 (i.e., 9<<2=9*22=36). If the quantity “N−e” is less than zero, then the intermediate value i₁ is right shifted by “|(N−e)|” bits.

Multiplication operation 460 multiplies intermediate value i₂ and highest set bit e, and outputs intermediate value i₄ to addition operation 470. In this embodiment, intermediate value i₄ is a 16 bit value. For example, if i₂ has a value of 200 and highest set bit e has a value of 4, then intermediate value i₄ has a value of 800 (i.e., 200*4=800).

LUT operation 402 includes a look-up table that is a read-only storage area which implements m log₂ m, where m is a value restricted to the numerical range 1 to 2. Depending on the number of quantization levels chosen, based on the required level of precision, the value of m which is compatible with this range is derived from the incoming 8-bit value, quantized and then normalized, and subsequently used as an index into the look-up table. In one embodiment, the look-up table may be multi-ported for fast accesses within a small number of clock cycles; in another embodiment, look-up table accesses may be pipelined in order to serve requests from multiple vector lanes over multiple clock cycles. Because ANNs are inherently imprecise, the acceptable latency of the instruction, the storage size of the look-up table, and the accuracy of the m·log₂ m implementation may be balanced against one another. However, rather than simply reducing the precision of all the operands in the entropy calculation, embodiments of the present disclosure degrade accuracy in a more controlled manner and ensure that the results are numerically consistent.

LUT operation 402 receives intermediate value i₃, determines the value in the look-up table using the intermediate value i₃ as an index, and outputs intermediate value i₅ to addition operation 470. For example, if the look-up table has 64 entries and intermediate value i₃ has a value of 36, the intermediate value i₅ has a value of 129.

Addition operation 470 receives intermediate value i₄ and intermediate value i₅, determines their sum, and outputs the sum as intermediate value i₆. For example, if intermediate value i₄ has a value of 800 and intermediate value i₅ has a value of 129, then intermediate value i₆ has a value of 929 (i.e., 800+129=929).

Right shift operation 480 receives intermediate value i₆ and y, right shifts intermediate value i₆ by y bits, and outputs the intermediate value i₇ to pairwise addition operation 490. For example, if intermediate value i₆ has a value of 929 and y has a value of 3, then intermediate value i₇ has a value of 116 (i.e., 929<<3=└929/2³┘=└116.125┘=116). For comparison, the entropy of operand p is 116.096, as determined by Equation 1 (i.e., 25*log₂(25)=25*4.643856=116.096), as well as Equation 3 (i.e., m=1.5625 and e=4, and (1.5625·4+1.5625·log₂(1.5625))<<4=(6.25+1.006025)<<4=7.256025*2⁴=116.096).

Pairwise addition operation 490 receives intermediate value i₇ and an intermediate value i_{AL} from an adjacent lane (AL), determines their sum, and outputs the sum as the final result r. In other embodiments, intermediate value i₇ is output as the final result r.

FIG. 6B depicts the operational semantics 400 of a processor instruction for calculating entropy, in accordance with embodiments of the present disclosure. The values for the examples discussed above have been overlaid onto FIG. 6A.

FIG. 6C depicts a look-up table 404, in accordance with an embodiment of the present disclosure. Generally, look-up table 404 has a number of values, n. In the embodiment depicted in FIG. 6C, n is 64, and the table index starts at 0 and ends at 63. For example, at index 36, the value is 129.

Given a packed vector “z1” with 8-bit values representing outputs from the Softmax layer for various classes such that values in the traditional floating-point range (0 to 1) map to integers in the range 0 to 255, the entropy may be computed as follows:
NTRPY z2.h, p1/z, z1.b
UADDV d0, p0, z2.h

The subsequent UADDV instruction performs a reduction operation, adding all 16-bit values in z2 (i.e., in vector lanes whose corresponding predicate in p0 is TRUE) and subsequently returning a scalar value representing the entropy. The arguments include z1 (the vector source register), z2 (the vector destination register of the first operation and the vector source register of the second operation), p1 (the predicate), b (the element size of the source register, e.g., 8-bit elements), h (the element size of the destination register, e.g., 16-bit elements), p0 (the predicate), and d0 (the scalar destination register).

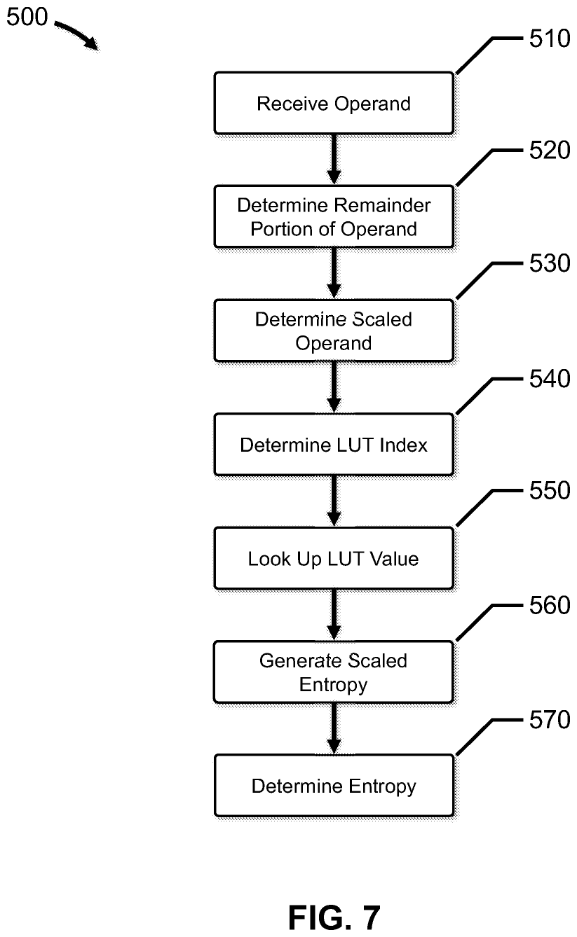

FIG. 7 depicts a flow diagram 500 presenting functionality for calculating entropy for certainty-based classification networks, in accordance with an embodiment of the present disclosure.

At 510, an integer operand p is received. As discussed above, in many embodiments, entropy module 220 may be implemented as a processor instruction. In these embodiments, after the NTRPY processor instruction has been called and the arguments decoded, each operand p is processed according to operational semantics 400.

At 520, a remainder portion of the integer operand p is determined based on a range reduction operation. In many embodiments, the range reduction operation includes determining a highest set bit, e, of the integer operand p, and determining the remainder portion of the integer operand p by subtracting 2^{e} from the integer operand p. For example, HSB operation 410 receives operand p, determines highest set bit e, i.e., the highest bit position, from left to right, of the first bit set to 1, and outputs highest set bit e to subtraction operation 420, subtraction operation 430, left shift operation 450 and multiplication operation 460, and then subtraction operation 430 receives operand p and highest set bit e, determines the quantity “p−2^{e},” and outputs the intermediate value i₁, as the remainder portion, to left shift operation 450. Other range reduction techniques are also contemplated.

At 530, a scaled integer operand is determined based on the integer operand p. For example, left shift operation 440 receives operand p and y, left shifts operand p by y bits, and outputs the intermediate value i₂ to multiplication operation 460, and multiplication operation 460 multiplies intermediate value i₂ and highest set bit e, and outputs intermediate value i₄, as the scaled integer operand, to addition operation 470.

At 540, an index for a look-up table (LUT) is determined based on the remainder portion of the integer operand p, the highest set bit e, and a parameter, N, associated with the data structure or LUT. For example, left shift operation 450 receives intermediate value i₁ and highest set bit e, determines the quantity “N−e,” left shifts the intermediate value i₁ by “N−e” bits, and outputs the intermediate value i₃, as the index, to LUT operation 402.

At 550, a LUT value is looked up in the data structure or LUT based on the index. For example, LUT operation 402 receives intermediate value i₃, determines the value in the look-up table using the intermediate value i₃ as an index, and outputs intermediate value is, as the LUT value, to addition operation 470.

At 560, a scaled entropy value is generated by adding the LUT value to the scaled integer operand. For example, addition operation 470 receives intermediate value i₄ and intermediate value i₅, determines their sum, and outputs the sum as intermediate value i₆, the scaled entropy value.

At 570, an entropy value is determined based on the scaled entropy value. For example, right shift operation 480 receives intermediate value i₆ and y, right shifts intermediate value i₆ by y bits, and outputs the intermediate value i₇ to pairwise addition operation 490. The entropy value is then outputted.

Generally, after the architectures of the main classifier and each expert classifier have been designed, including, for example, the input, hidden and output layers of an ANN, the convolutional, pooling, fully-connected, and normalization layers of a CNN, the fully-connected and binary activation layers of a BNN, the SVM classifiers, etc., the main classifier and each expert classifier are rendered in software in order to train the weights/parameters within the various classification layers. The resulting pre-trained main classifier and each pre-trained expert classifier may be implemented by HA 200 in several ways.

For an HA 200 that includes one or more processors, microprocessors, microcontrollers, etc., such as, for example, a GPU, a DSP, an NPU, etc., the pre-trained main classifier software implementation and each pre-trained expert classifier software implementation are adapted and optimized to run on the local processor. In these examples, the MC module, the EC modules and the final predicted class decision module are software modules. For an HA 200 that includes programmable circuitry, such as an ASIC, an FPGA, etc., the programmable circuitry is programmed to implement the pre-trained main classifier software implementation and each pre-trained expert classifier software implementation. In these examples, the MC module, the EC modules and the final predicted class decision module are hardware modules. Regardless of the specific implementation, HA 200 provides hardware-based acceleration for the main classifier and each expert classifier.

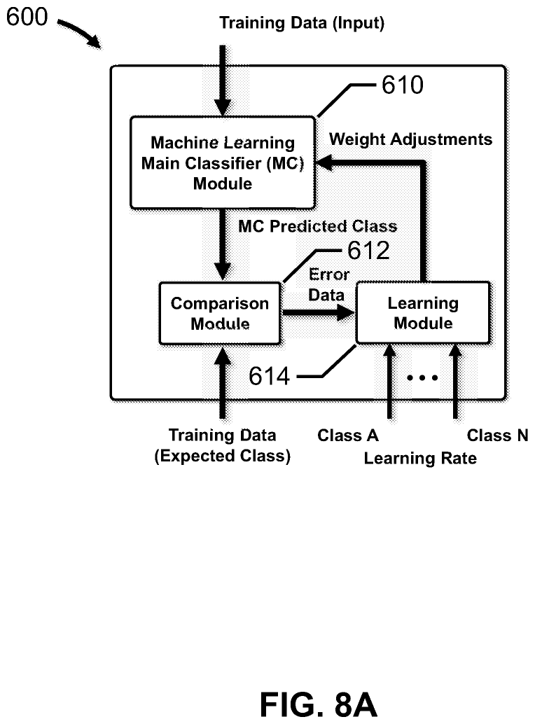

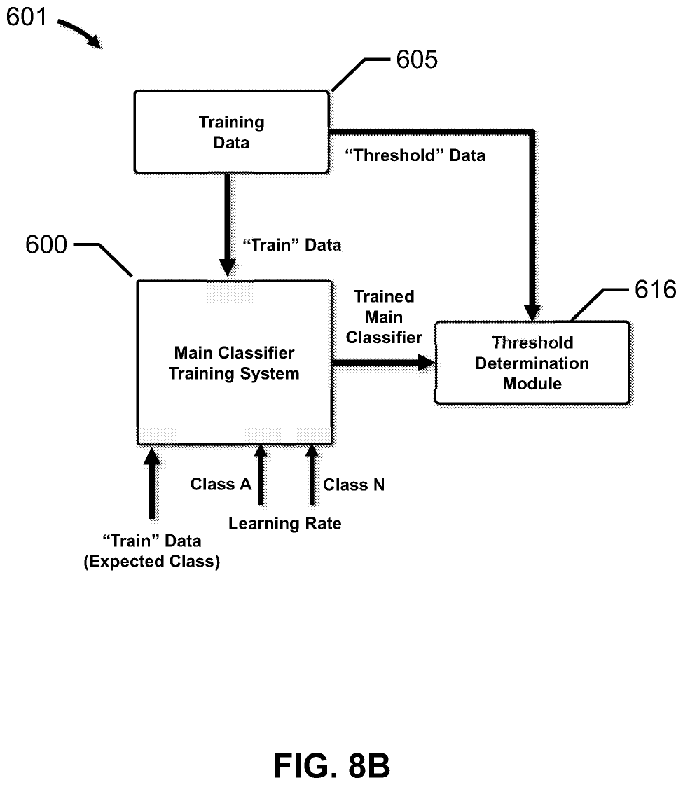

FIG. 8A depicts a block diagram of a training system 600 for a machine learning main classifier, in accordance with an embodiment of the present disclosure.

Training system 600 is a computer system that includes one or more processors, a memory, etc., that executes one or more software modules that train the main classifier included within MC 1 module 210-1, . . . , MC N_{M} module 210-N_{M}. The software modules include machine learning main classifier module 610, comparison module 612 and learning module 614. In order to create a diverse classification network, each main classifier may have a different architecture, a different training methodology, different training data, etc. For brevity, the training of the main classifier 1 within MC 1 module 210-1 is discussed below.

Initially, machine learning main classifier module 610 includes an untrained version of the main classifier included within MC 1 module 210-1. Generally, the main classifier includes one or more expert classes and several non-expert classes.

During each training cycle, machine learning main classifier module 610 receives training data (input) and determines an MC predicted class and uncertainty based on the input, comparison module 612 receives and compares the training data (expected class) to the MC predicted class and outputs error data, and learning module 614 receives the error data and the learning rate(s) for all of the classes, and determines and sends the weight adjustments to main classifier module 610. In many embodiments, the certainty is based on the entropy calculation discussed above, and the predetermined threshold is determined during training. Generally, a threshold can be determined during training by analyzing values of precision and recall in a test set and verifying whether these values conform to design specifications and acceptable safety standards.

In some embodiments, the main classifier may be trained using a single learning rate for all of the classes. A low training rate may lead to longer training times, and the main classifier might never converge successfully or provide sufficiently accurate classifications. Conversely, a high learning rate would reduce training time, but the result might be unreliable or sub-optimal. In one embodiment, learning module 614 provides a supervised learning process to train the main classifier using completely-labeled training data that include known input-output pairs. In another embodiment, learning module 614 provides a semi-supervised or weakly-supervised learning process to train the main classifier using incomplete training data, i.e., a small amount of labeled data (i.e., input-output pairs) and a large amount of unlabeled data (input only). In a further embodiment, learning module 614 provides an unsupervised learning process to train the main classifier using unlabeled data (i.e., input only).

FIG. 8B depicts a block diagram of a threshold determination process 601 for a machine learning main classifier, in accordance with an embodiment of the present disclosure.

In many embodiments, training data 605 may be divided into “train” data and “threshold” data in a particular ratio, such as, for example, 92%: 8%. While the ratio may vary, generally, the “train” data %>>“threshold” data %. The main classifier training is performed by training system 600 using the “train” data, as described above. Once training is completed, threshold determination module 616 uses the “threshold” data to determine the predetermined threshold. Inference is performed using the “threshold” data on the trained main classifier. For each sample in the “threshold” data, the entropy is calculated based on the output probabilities, which results in a range of entropy values from entropyₘᵢₙ to entropyₘₐₓ.

Embodiments of the present disclosure advantageously provide a quick way of computing one key metric which can be used in classification networks to estimate the uncertainty associated with a given response or output, including a method and an architecture extension which ensures that arithmetic errors, which might arise if rounding and/or truncation operations are not performed properly, can be mitigated whilst retaining the efficiency benefits of integer arithmetic.

The embodiments described above and summarized below are combinable.

In one embodiment, a hardware accelerator for certainty-based classification networks includes a processor configured to receive an integer operand p, determine a remainder portion of the integer operand p based on a range reduction operation, determine a scaled integer operand based on the integer operand p, determine an index for a data structure based on the remainder portion of the integer operand p and a parameter N associated with the data structure, look up a data structure value in the data structure based on the index, generate a scaled entropy value by adding the data structure value to the scaled integer operand, determine an entropy value based on the scaled entropy value, and output the entropy value to a main classifier configured to determine a binary certainty value for a predicted class based on the entropy value.

In another embodiment of the hardware accelerator, the data structure is a look-up table.

In another embodiment of the hardware accelerator, the processor is further configured to generate a pairwise entropy value by adding an additional entropy value from an adjacent vector lane to the entropy value; and output the pairwise entropy value.

In another embodiment of the hardware accelerator, e even numbered vector lanes and odd numbered vector lanes are processed alternately.

In another embodiment of the hardware accelerator, the range reduction operation includes determine a highest set bit e of the integer operand p, where e is the highest bit position, from left to right, of the first bit set to 1; and determine the remainder portion of the integer operand p by subtracting 2e from the integer operand p.

In another embodiment of the hardware accelerator, m is equal to the integer operand p divided by 2e and the data structure approximates the relationship m·log 2(m); the data structure has a number of values n; the parameter N is equal to log 2(n); and said determine the index includes determine a first shift value by subtracting the highest set bit e from the parameter N, and perform a left shift operation, using the first shift value, on the remainder portion of the integer operand p to generate the index.

In another embodiment of the hardware accelerator, when the first shift value is greater than or equal to zero, perform the left shift operation; and when the first shift value is less than zero, perform a right shift operation, using an absolute value of the first shift value, on the remainder portion of the integer operand p to generate the index.

In another embodiment of the hardware accelerator, said determine the scaled integer operand includes determine a second shift value by subtracting the highest set bit e from a predetermined integer value; perform a left shift operation, using the second shift value, on the integer operand to generate an initial scaled integer operand; and generate the scaled integer operand by multiplying the initial scaled integer operand and the highest set bit e.

In another embodiment of the hardware accelerator, said determine the entropy value includes perform a right shift operation, using the second shift value, on the scaled entropy value to generate the entropy value.

In another embodiment of the hardware accelerator, the integer operand p is an 8-bit value, the highest set bit e is a 3-bit value, the data structure value is an 8 bit value, the scaled integer operand p is a 16-bit value, and the entropy value is a 16-bit value.

In one embodiment, a method for calculating entropy for certainty-based classification networks includes receiving an integer operand p, where e is the highest bit position, from left to right, of the first bit set to 1; determining a remainder portion of the integer operand p based on a range reduction operation; determining a scaled integer operand based on the integer operand p; determining an index for a data structure based on the remainder portion of the integer operand p and a parameter N associated with the data structure; looking up a data structure value in the data structure based on the index; generating a scaled entropy value by adding the data structure value to the scaled integer operand; determining an entropy value based on the scaled entropy value; and outputting the entropy value to a main classifier configured to determine a binary certainty value for a predicted class based on the entropy value.

In another embodiment of the method, the data structure is a look-up table.

In another embodiment of the method, the method further comprises generating a pairwise entropy value by adding an additional entropy value from an adjacent vector lane to the entropy value; and outputting the pairwise entropy value.

In another embodiment of the method, even numbered vector lanes and odd numbered vector lanes are processed alternately.

In another embodiment of the method, the range reduction operation includes determining a highest set bit e of the integer operand p, where e is the highest bit position, from left to right, of the first bit set to 1; and determining the remainder portion of the integer operand p by subtracting 2e from the integer operand p.

In another embodiment of the method, m is equal to the integer operand p divided by 2e and the data structure approximates the relationship m·log 2(m); the data structure has a number of values n; the parameter N is equal to log 2(n); and said determining the index includes determining a first shift value by subtracting the highest set bit e from the parameter N, and performing a left shift operation, using the first shift value, on the remainder portion of the integer operand p to generate the index.

In another embodiment of the method, when the first shift value is greater than or equal to zero, performing the left shift operation; and when the first shift value is less than zero, performing a right shift operation, using an absolute value of the first shift value, on the remainder portion of the integer operand p to generate the index.

In another embodiment of the method, said determining the scaled integer operand includes determining a second shift value by subtracting the highest set bit e from a predetermined integer value; performing a left shift operation, using the second shift value, on the integer operand to generate an initial scaled integer operand; and generating the scaled integer operand by multiplying the initial scaled integer operand and the highest set bit e.

In another embodiment of the method, said determining the entropy value includes performing a right shift operation, using the second shift value, on the scaled entropy value to generate the entropy value.

In another embodiment of the method, the integer operand p is an 8-bit value, the highest set bit e is a 3-bit value, the data structure value is an 8 bit value, the scaled integer operand p is a 16-bit value, and the entropy value is a 16-bit value.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “some embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A hardware accelerator for certainty-based classification networks, comprising:
a processor configured to:
receive an integer operand p;
determine a remainder portion of the integer operand p based on a range reduction operation;
determine a scaled integer operand based on the integer operand p;
determine an index for a data structure based on the remainder portion of the integer operand p and a parameter N associated with the data structure;
look up a data structure value in the data structure based on the index;
generate a scaled entropy value by adding the data structure value to the scaled integer operand;
determine an entropy value based on the scaled entropy value; and
output the entropy value to a main classifier configured to determine a binary certainty value for a predicted class based on the entropy value.

2. The hardware accelerator according to claim 1, where the data structure is a look-up table.

3. The hardware accelerator according to claim 1, where the processor is further configured to:
generate a pairwise entropy value by adding an additional entropy value from an adjacent vector lane to the entropy value; and
output the pairwise entropy value.

4. The hardware accelerator according to claim 3, where even numbered vector lanes and odd numbered vector lanes are processed alternately.

5. The hardware accelerator according to claim 1, where the range reduction operation includes:
determine a highest set bit e of the integer operand p, where e is the highest bit position, from left to right, of the first bit set to 1; and
determine the remainder portion of the integer operand p by subtracting 2^{e} from the integer operand p.

6. The hardware accelerator according to claim 5, where:
m is equal to the integer operand p divided by 2^{e} and the data structure approximates the relationship m·log₂(m);
the data structure has a number of values n;
the parameter N is equal to log₂(n); and
said determine the index includes:
determine a first shift value by subtracting the highest set bit e from the parameter N, and
perform a left shift operation, using the first shift value, on the remainder portion of the integer operand p to generate the index.

7. The hardware accelerator according to claim 6, where:
when the first shift value is greater than or equal to zero, perform the left shift operation; and
when the first shift value is less than zero, perform a right shift operation, using an absolute value of the first shift value, on the remainder portion of the integer operand p to generate the index.

8. The hardware accelerator according to claim 7, where said determine the scaled integer operand includes:
determine a second shift value by subtracting the highest set bit e from a predetermined integer value;
perform a left shift operation, using the second shift value, on the integer operand to generate an initial scaled integer operand; and
generate the scaled integer operand by multiplying the initial scaled integer operand and the highest set bit e.

9. The hardware accelerator according to claim 8, where said determine the entropy value includes perform a right shift operation, using the second shift value, on the scaled entropy value to generate the entropy value.

10. The hardware accelerator according to claim 5, where the integer operand p is an 8-bit value, the highest set bit e is a 3-bit value, the data structure value is an 8 bit value, the scaled integer operand p is a 16-bit value, and the entropy value is a 16-bit value.

11. A method for calculating entropy for certainty-based classification networks, comprising:
receiving an integer operand p;
determining a remainder portion of the integer operand p based on a range reduction operation;
determining a scaled integer operand based on the integer operand p;
determining an index for a data structure based on the remainder portion of the integer operand p and a parameter N associated with the data structure;
looking up a data structure value in the data structure based on the index;
generating a scaled entropy value by adding the data structure value to the scaled integer operand;
determining an entropy value based on the scaled entropy value; and
outputting the entropy value to a main classifier configured to determine a binary certainty value for a predicted class based on the entropy value.

12. The method according to claim 11, where the data structure is a look-up table.

13. The method according to claim 11, further comprising:
generating a pairwise entropy value by adding an additional entropy value from an adjacent vector lane to the entropy value; and
outputting the pairwise entropy value.

14. The method according to claim 13, where even numbered vector lanes and odd numbered vector lanes are processed alternately.

15. The method according to claim 11, where the range reduction operation includes:
determining a highest set bit e of the integer operand p, where e is the highest bit position, from left to right, of the first bit set to 1; and
determining the remainder portion of the integer operand p by subtracting 2^{e} from the integer operand p.

16. The method according to claim 15, where:
m is equal to the integer operand p divided by 2^{e} and the data structure approximates the relationship m·log₂(m);
the data structure has a number of values n;
the parameter N is equal to log₂(n); and
said determining the index includes:
determining a first shift value by subtracting the highest set bite from the parameter N, and
performing a left shift operation, using the first shift value, on the remainder portion of the integer operand p to generate the index.

17. The method according to claim 16, where:
when the first shift value is greater than or equal to zero, performing the left shift operation; and
when the first shift value is less than zero, performing a right shift operation, using an absolute value of the first shift value, on the remainder portion of the integer operand p to generate the index.

18. The method according to claim 17, where said determining the scaled integer operand includes:
determining a second shift value by subtracting the highest set bit e from a predetermined integer value;
performing a left shift operation, using the second shift value, on the integer operand to generate an initial scaled integer operand; and
generating the scaled integer operand by multiplying the initial scaled integer operand and the highest set bit e.

19. The method according to claim 18, where said determining the entropy value includes performing a right shift operation, using the second shift value, on the scaled entropy value to generate the entropy value.

20. The method according to claim 15, where the integer operand p is an 8-bit value, the highest set bit e is a 3-bit value, the data structure value is an 8 bit value, the scaled integer operand p is a 16-bit value, and the entropy value is a 16-bit value.
